(19) United States
(12) Patent Application Publication
(10) Pub. No.: US 2025/0296591 A1
(43) Pub. Date: Sep. 25, 2025

(54) DRIVING ASSISTANCE SYSTEM

(71) Applicant: TOYOTA JIDOSHA KABUSHIKI KAISHA, Toyota-shi (JP)

(72) Inventor: Kentaro MATSUMOTO, Yokohama-shi (JP)

(73) Assignee: TOYOTA JIDOSHA KABUSHIKI KAISHA, Toyota-shi (JP)

(21) Appl. No.: 19/033,912

(22) Filed: Jan. 22, 2025

(30) Foreign Application Priority Data
Mar. 19, 2024 (JP) 2024-043446

(51) Int. Cl. B60W 50/14; B60W 30/12

(52) U.S. Cl. CPC B60W 50/14; B60W 30/12; B60W 2050/146; B60W 2540/223

(57) ABSTRACT

A driving assistance system is a system capable of continuing travel control of a vehicle in a state where a driver of the vehicle does not hold a steering wheel. A driving assistance system calculates an arrival time until the vehicle arrives at a caution area, and permits the travel control in a state where the driver does not hold the steering wheel when the arrival time is longer than a set hands-off permission time.

### TECHNICAL FIELD

The present disclosure relates to a driving assistance system.

### BACKGROUND

As a technology related to a driving assistance system, for example, Japanese Unexamined Patent Publication No. 2022-176869 discloses a technology that enables automated traveling by autonomous travel control without a driver's obligation of monitoring the surroundings and a driver's obligation of gripping a steering wheel in a host vehicle when a traffic jam around the host vehicle is grasped in an automated driving possible area.

### SUMMARY

By the way, in a driving assistance system capable of continuing travel control such as lane keeping control in a state where the driver of a vehicle does not hold the steering wheel (hereinafter, also referred to as “hands-off”), when the vehicle is located within a certain distance with respect to a caution area such as an intersection, for example, it is conceivable that travel control in a hands-off state is not permitted in order to ensure safety. In such a driving assistance system, when the vehicle approaches the caution area, for example, in a situation where the traffic flow is slow, the travel control may be restricted even though the travel control in a hands-off state can be continued for a sufficient time.

Therefore, an object of the present disclosure is to provide a driving assistance system capable of suppressing restriction of travel control in a state where a driver does not hold a steering wheel more than necessary.

(1) A driving assistance system according to the present disclosure is a driving assistance system capable of continuing travel control of a vehicle in a state where a driver of the vehicle does not hold a steering wheel, the driving assistance system including calculating an arrival time until the vehicle arrives at a caution area, and permitting the travel control in a state where the driver does not hold the steering wheel when the arrival time is longer than a set hands-off permission time.

In this driving assistance system, the travel control in a hands-off state can be permitted on the basis of the arrival time until the vehicle arrives at a caution area. Therefore, for example, when the vehicle approaches the caution area in a situation where the traffic flow is slow, it is possible to suppress the travel control in a hands-off state from being restricted more than necessary.

(2) In the driving assistance system described in (1) above, the caution area may be at least one of an intersection, a construction section, a section including an accident site, and a high-frequency accident occurrence section. In this case, at least one of an intersection, a construction section, a section including an accident site, and a high-frequency accident occurrence section can be considered as the caution area.

(3) In the driving assistance system described in (1) or (2) above, the hands-off permission time may be determined according to a type of the caution area. In this case, the above-described effect of suppressing the travel control in a hands-off state from being restricted more than necessary according to the type of the caution area can be exhibited.

(4) In the driving assistance system described in any one of (1) to (3) above, the travel control in a state where the driver does not hold the steering wheel may not be permitted when the arrival time is equal to or less than the hands-off permission time. In this case, when the arrival time is equal to or less than the hands-off permission time and the vehicle soon arrives at the caution area, for example, the travel control can be restricted so that the travel control in a hands-off state is not performed.

(5) The driving assistance system described in (4) above may request the driver to drive when the travel control in a state where the driver does not hold the steering wheel is not permitted, the driving assistance system may request the driver to drive in a state of holding the steering wheel (hereinafter, also referred to as “hands-on”). Thus, when the travel control in a hands-off state is not permitted, the driver can be urged to perform hands-on driving.

According to the present disclosure, it is possible to provide a driving assistance system capable of suppressing travel control in a state where a driver does not hold a steering wheel from being restricted more than necessary.

### BRIEF DESCRIPTION OF THE DRAWINGS

FIG. 1 is a block diagram showing an overall configuration of a driving assistance system according to an embodiment;

FIG. 2 is a flowchart showing processing of the driving assistance system of FIG. 1;

FIG. 3A is a schematic diagram showing an example of a range in which hands-off is permitted by a driving assistance system according to a comparative example; and FIG. 3B is a schematic diagram showing an example of a range in which hands-off is permitted by the driving assistance system of FIG. 1.

### DETAILED DESCRIPTION

Hereinafter, embodiments will be described with reference to the accompanying drawings. In the following description, the same or corresponding elements are denoted by the same reference signs, and redundant description will be omitted.

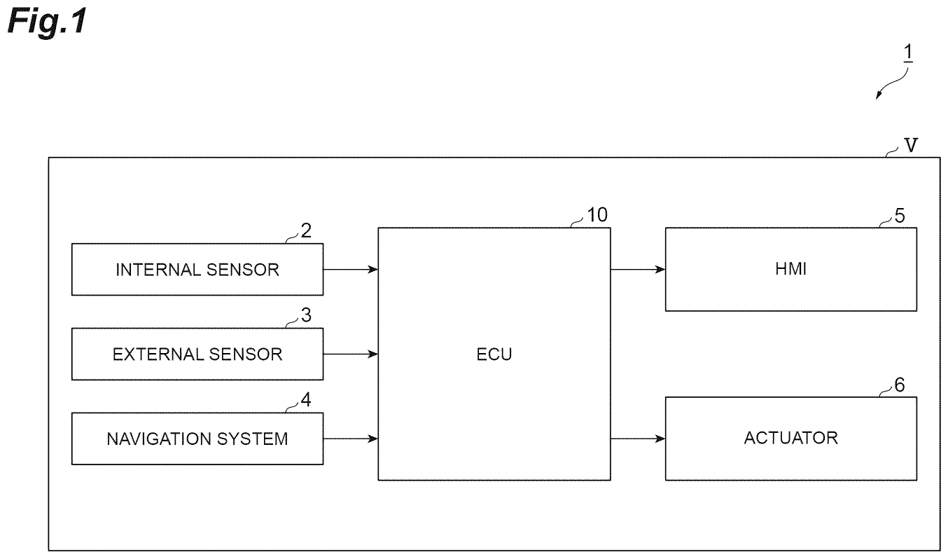

As shown in FIG. 1, a driving assistance system 1 according to the present embodiment is mounted on a vehicle V. The vehicle V may be a passenger vehicle or a cargo vehicle. One or more occupants can board the vehicle V. The vehicle V may be an autonomous driving vehicle capable of autonomous driving. The vehicle V may be manually driven by the driver.

The driving assistance system 1 is a system capable of continuing travel control of the vehicle V in a state where a driver of the vehicle V does not hold a steering wheel (hereinafter, also referred to as “hands-off”). The travel control is, for example, lane keeping control (lane keeping assist (LKA)) in which the vehicle V is automatically steered so as not to deviate from the travel lane on which the vehicle V travels. The travel control is not particularly limited, and may be travel control related to other driving assistance. The driving assistance system 1 includes an electronic control unit (ECU) 10.

The ECU 10 is an electronic control unit including a central processing unit (CPU), a read only memory (ROM), and a random access memory (RAM). The ECU 10 implements various functions by, for example, loading a program stored in the ROM into the RAM and executing the program loaded in the RAM by the CPU. A part of the functions of the ECU 10 may be executed in a server that can communicate with the vehicle V. The ECU 10 may include a plurality of electronic units. The internal sensor 2, the external sensor 3, the navigation system 4, the HMI 5, and the actuator 6 are connected to the ECU 10.

The internal sensor 2 is a detection device that detects a traveling state of the vehicle V. The internal sensor 2 includes a vehicle speed sensor, an acceleration sensor, and a yaw rate sensor. The vehicle speed sensor is a detector that detects a speed of the vehicle V. For example, a wheel speed sensor that detects a rotation speed of a wheel is used as the vehicle speed sensor. The vehicle speed sensor transmits detected vehicle speed information to the ECU 10. The acceleration sensor is a detector that detects an acceleration of the vehicle V. The acceleration sensor transmits, for example, acceleration information of the vehicle V to the ECU 10. The yaw rate sensor is a detector that detects a yaw rate (rotation angular velocity) around a vertical axis of a center of gravity of the vehicle V. For example, a gyro sensor can be used as the yaw rate sensor. The yaw rate sensor transmits the detected yaw rate information of the vehicle V to the ECU 10.

The external sensor 3 is a detection device that detects a surrounding environment of the vehicle V. The external sensor 3 includes a camera and a radar sensor. The camera is provided, for example, on a back side of a windshield of the vehicle V and images the front of the vehicle V. The camera may be provided on a back surface and a side surface of the vehicle V. The camera transmits imaging information around the vehicle V to the ECU 10. The camera may be a monocular camera or a stereo camera. The radar sensor is a detection device that detects an obstacle around the vehicle V by using radio waves (for example, millimeter waves) or light. The radar sensor includes, for example, a millimeter wave radar or a lidar. The radar sensor transmits the detected obstacle information to the ECU 10.

The navigation system 4 is a system that guides the driver of the vehicle V to a preset destination. The navigation system 4 recognizes a traveling road and a traveling lane on which the vehicle V travels on the basis of the position of the vehicle V measured by the GPS receiving unit and map information in the map database. The navigation system 4 calculates a target route from the position of the vehicle V to the destination, and guides the driver to the target route using the HMI 5.

The HMI 5 is an interface for inputting and outputting information to and from the driver. The HMI 5 includes, for example, a display and a speaker that can be visually recognized by the driver. The HMI 5 outputs an image from the display and outputs a sound from the speaker in response to a control signal from the ECU 10. The HMI 5 may include a head up display (HUD).

The actuator 6 is a device used for controlling the vehicle V. The actuator 6 includes at least a drive actuator, a brake actuator, and a steering actuator. The drive actuator controls an engine and/or a motor as a power source in response to a control signal from the ECU 10 to control a driving force of the vehicle V. The brake actuator controls a brake system in response to a control signal from the ECU 10 to control a braking force to be applied to wheels of the vehicle V. The steering actuator controls driving of an assist motor that controls a steering torque in an electric power steering system in response to a control signal from the ECU 10. Accordingly, the steering actuator controls the steering torque of the vehicle V.

The ECU 10 executes travel control of the vehicle V. For example, when lane keeping control is performed as travel control, the ECU 10 executes steering control for causing the vehicle V to travel so as to keep the lane on the basis of detection results of the internal sensor 2 and the external sensor 3.

The ECU 10 according to the present embodiment calculates an arrival time T until the vehicle V arrives at a caution area. The caution area is an area requiring caution. The caution area is an area with low safety levels. The caution area is at least one of an intersection, a construction section, a section including an accident site, and a high-frequency accident occurrence section. For example, the intersection, the construction section, the section including an accident site, and the high-frequency accident occurrence section may be set in advance on the basis of the map database of the navigation system 4 and stored in the ECU 10.

Specifically, the ECU 10 calculates an arrival distance X to the caution area on the basis of the map database of the navigation system 4 and the detection result of the external sensor 3. The ECU 10 calculates a traffic flow Y on the basis of a detection result of the internal sensor 2 and the traffic-related information (traffic-related information that can be obtained, for example, via Vehicle Information and Communication System [VICS] (registered trademark)). The arrival time T is calculated by the following equation from the calculated arrival distance X and the traffic flow Y.

$$T ( s ) = X ( m ) / Y ( m / s )$$

As described below, the ECU 10 permits the travel control in a hands-off state when the arrival time T is longer than a set hands-off permission time S, and does not permit the travel control in a hands-off state when the arrival time T is equal to or shorter than the hands-off permission time S. The hands-off permission time S is determined according to the type of the caution area. The hands-off permission time S is stored in the ECU 10.
T(s)>S(s)→permitted
T(s)≤S(s)→not permitted

When the travel control in a hands-off state is not permitted, the ECU 10 requests the driver to drive in a state of holding the steering wheel (hereinafter, also referred to as “hands-on”). As an example, the ECU 10 may transmit a control signal to the HMI 5 to display a notification for prompting the driver to operate the vehicle in a hands-on state on the display of the HMI 5 or to output a sound and a buzzer for prompting the driver to perform hands-on driving from the speaker of the HMI 5 as the request to the driver.

The ECU 10 determines whether or not the state of the driver is a hands-on state after the request for hands-on driving. Whether or not the state of the driver is a hands-on state can be determined using, for example, outputs from a touch sensor of a steering unit (steering), a torque sensor, a driver monitoring camera, and the like. As a result of the determination, the ECU 10 continues the travel control when the driver state is a hands-on state, and ends the travel control when the driver state is not a hands-on state.

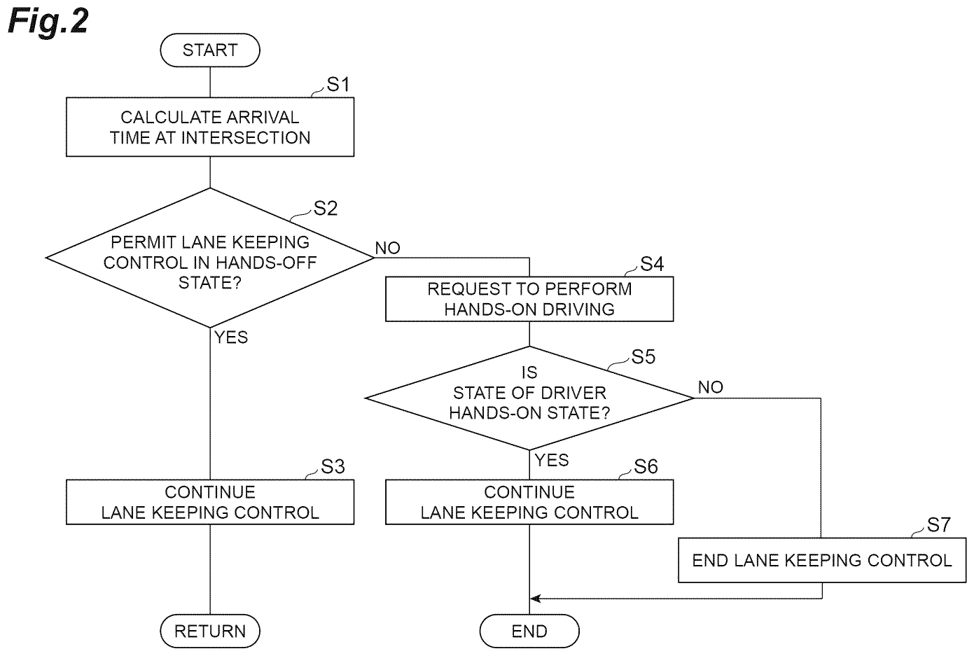

Next, processing of the driving assistance system 1 will be described with reference to a flowchart of FIG. 2. Hereinafter, an example will be described where the caution area is an intersection and lane keeping control is performed as travel control.

When there is an intersection ahead of the vehicle V traveling in a hands-off state and the lane keeping control is being continued, the following processing is executed. First, the ECU 10 calculates an arrival time T at an intersection (step S1). The ECU 10 determines whether or not the arrival time T is longer than the hands-off permission time S, thereby determining whether or not to permit the lane keeping control in a hands-off state (step S2). If YES in step S2, the lane keeping control in a hands-off state is permitted and the lane keeping control is continued (step S3). Thereafter, the processing of this cycle is ended, and the processing proceeds to processing of step S1 of the next cycle.

If NO in step S2, the lane keeping control in a hands-off state is not permitted, and the ECU 10 requests the driver to perform hands-on driving (step S4). It is determined whether or not the state of the driver is a hands-on state (step S5). If YES in step S5, the lane keeping control is continued (step S6). On the other hand, if NO in step S5, the lane keeping control is ended (step S7). After steps S6 and S7, the processing ends.

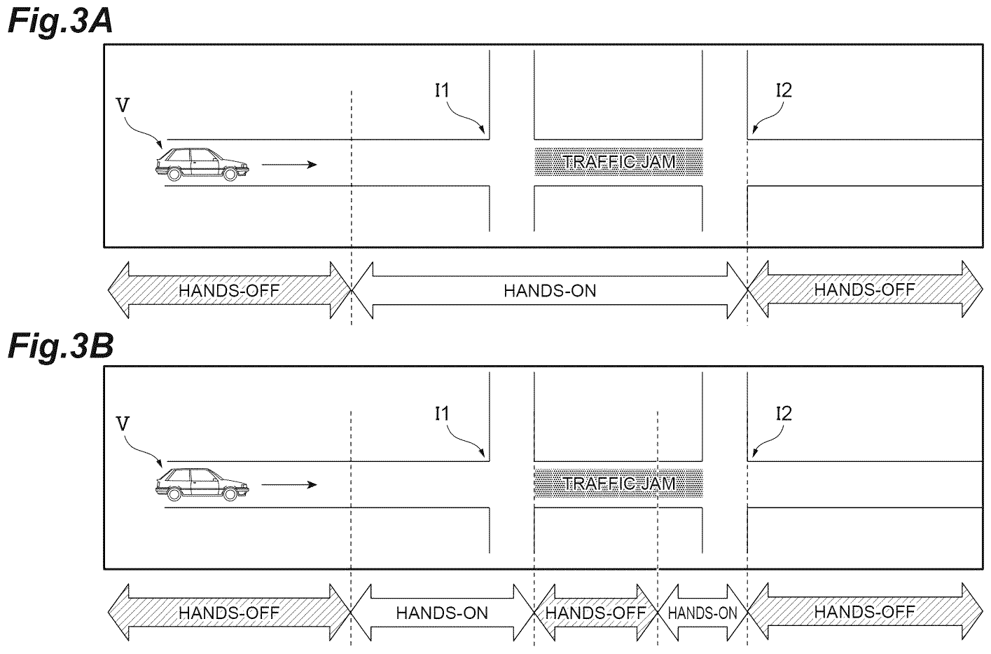

FIG. 3A is a schematic diagram showing an example of a range in which hands-off is permitted by a driving assistance system according to a comparative example; and FIG. 3B is a schematic diagram showing an example of a range in which hands-off is permitted by the driving assistance system 1. In the example of FIGS. 3A and 3B, two intersections I1 and I2 exist ahead in the traveling direction of the vehicle V, and a traffic jam (a situation where the traffic flow is slow) occurs between the intersection I1 and the intersection I2. The comparative example corresponds to a driving assistance system that does not permit travel control in a hands-off state when the vehicle V is located within a certain distance from the intersections I1 and I2 ahead in the traveling direction of the vehicle V.

As shown in FIG. 3A, in the driving assistance system according to the comparative example, the travel control in a hands-off state is permitted until the distance to the intersection I1 of the vehicle V becomes a certain distance. After the distance to the intersection I1 of the vehicle V becomes equal to or less than a certain distance, the travel control in a hands-off state is not permitted, and the travel control in a hands-on state is requested. After the vehicle V enters and exits the intersection I1, the distance to the intersection I2 of the vehicle V is constant, and thus the travel control in a hands-off state is continuously not permitted and the travel control in a hands-on state is required regardless of the traffic jam occurring ahead. Then, after the vehicle V enters and leaves the intersection I2, the travel control in a hands-off state is permitted.

On the other hand, as shown in FIG. 3B, in the driving assistance system 1 of the present embodiment, the travel control in a hands-off state is permitted until the arrival time T at the intersection I1 becomes equal to or less than the hands-off permission time S. After the arrival time T at the intersection I1 becomes equal to or less than the hands-off permission time S, the travel control in a hands-off state is not permitted, and the travel control in a hands-on state is requested. After the vehicle V enters and leaves the intersection I1, a traffic jam has occurred ahead and the traffic flow is slow, and thus the arrival time T at the intersection I1 is longer than the hands-off permission time S, whereby the travel control in a hands-off state is permitted regardless of the distance of the vehicle V to the intersection I2. After the arrival time T at the intersection I2 becomes equal to or less than the hands-off permission time S, the travel control in a hands-off state is not permitted, and the travel control in a hands-on state is requested. Then, after the vehicle V enters and leaves the intersection I2, the travel control in a hands-off state is permitted.

As described above, in the driving assistance system 1, the travel control in a hands-off state can be permitted on the basis of the arrival time T until the vehicle V arrives at the caution area. Therefore, for example, when the vehicle V approaches the caution area in a situation where the traffic flow is slow such as occurrence of traffic congestion, it is possible to suppress the travel control in a hands-off state from being restricted more than necessary. It is possible to determine whether or not the travel control in a hands-off state is possible in consideration of the distance to the caution area and the traffic flow, and it is possible to suppress the travel control in a hands-off state from being restricted more than necessary while reducing inconvenience.

In the driving assistance system 1, the caution area is at least one of an intersection, a construction section, a section including an accident site, and a high-frequency accident occurrence section. In this case, at least one of an intersection, a construction section, a section including an accident site, and a high-frequency accident occurrence section can be considered as the caution area.

In the driving assistance system 1, the hands-off permission time is determined according to the type of the caution area. In this case, the above-described effect that the travel control in a hands-off state can be suppressed from being restricted more than necessary according to the type of the caution area can be exhibited.

The driving assistance system 1 does not permit travel control in a hands-off state when the arrival time T is equal to or less than the hands-off permission time S. In this case, when the arrival time T is equal to or less than the hands-off permission time S and the vehicle arrives at the caution area soon, for example, the travel control can be restricted so that the travel control in a hands-off state is not performed.

The driving assistance system 1 requests the driver to perform hands-on driving when the travel control in a state where the driver does not hold the steering wheel is not permitted. Thus, when the travel control in a hands-off state is not permitted, the driver can be urged to perform hands-on driving.

Although the embodiment has been described above, one aspect of the present disclosure is not limited to the above-described embodiment. The aspect of the present disclosure can be performed in various forms with various modifications and improvements on the basis of knowledge of those skilled in the art, including the above-described embodiment.

In the above embodiment, an intersection, a construction section, a section including an accident site, and a high-frequency accident occurrence section are described as the caution area, but the caution area is not particularly limited and may be any other caution area. In the above embodiment, the notification by display and/or voice via the HMI 5 is employed as the request to perform hands-on driving, but the present disclosure is not limited thereto, and various notifications may be employed. For example, notification by seat vibration may be employed.

What is claimed is:

1. A driving assistance system capable of continuing travel control of a vehicle in a state where a driver of the vehicle does not hold a steering wheel, wherein the driving assistance system is configured to:
calculate an arrival time until the vehicle arrives at a caution area; and
permit the travel control in a state where the driver does not hold the steering wheel when the arrival time is longer than a set hands-off permission time.

2. The driving assistance system according to claim 1, wherein the caution area is at least one of an intersection, a construction section, a section including an accident site, and a high-frequency accident occurrence section.

3. The driving assistance system according to claim 1, wherein the hands-off permission time is determined according to a type of the caution area.

4. The driving assistance system according to claim 1, wherein the travel control in a state where the driver does not hold the steering wheel is not permitted when the arrival time is equal to or less than the hands-off permission time.

5. The driving assistance system according to claim 4, wherein, when the travel control in a state where the driver does not hold the steering wheel is not permitted, the driving assistance system requests the driver to drive in a state of holding the steering wheel.
